(19) United States
(12) Patent Application Publication
(10) Pub. No.: US 2012/0229119 A1
(43) Pub. Date: Sep. 13, 2012

(54) Device and Method for the Detection of the Rotor Position at Low Rotational Speeds or at a Standstill

(75) Inventor: Roberto Leidhold, Magdeburg (DE)

(73) Assignee: Technische-Universitat Darmstadt, Darnstadt (DE)

(21) Appl. No.: 13/394,749

(22) PCT Filed: Sep. 6, 2010
(86) PCT No.: PCT/EP10/63063

§ 371 Date: May 24, 2012

(30) Foreign Application Priority Data
Sep. 7, 2009 (EP) 09169806.0

(51) Int. Cl. G01B 7/30

(52) U.S. Cl. 324/71.1

(57) ABSTRACT

The invention describes a circuit arrangement and a method for the detection of the rotor position at low rotational speeds of rotors or at a standstill. For this, an HF signal is fed into the neutral point (zero sequence) and the rotor position is detected via the distribution of the HF signal in the coils (non-zero sequence).

The invention at hand refers to a circuit and method for the detection of the rotor position at low rotational speeds or at a standstill.

### DESCRIPTION OF, AND INTRODUCTION TO, THE GENERAL FIELD OF THE INVENTION

In electric motors, attempts are increasingly being made to dispense with sensors for detecting the number of revolutions and position. The advantage of this is that fewer components have to be integrated. Thus, the electric motor is less susceptible to failure.

The number of revolutions or position of the rotor can be indirectly detected via the measurement of purely electrical values (e.g. phase voltage and/or phase current).

In synchronous motors, the position of the rotor can be detected via electromotive force (EMF) or position-dependent inductance (also called anisotropy or magnetic saliency).

### STATE OF THE ART

Hereinafter, the motor rotor is referred to as rotor, independent of whether a rotational or translational movement is carried out or not. In the case of a translational movement, e.g. in linear motors, the detected position angles are converted into the corresponding distances traveled.

Methods for the recognition of the rotor position are already known.

In WO2004019269A2, a rotor position detection is described which is operated via pulse-width modulation. During a pulse pause, a high-frequency (HF) signal is fed into the electric motor. The rotor position is estimated using the received return signal. The fact that the HF response signal is modulated onto the normal pulses is disadvantageous. Thus, the pulses must be filtered accordingly, resulting in an inaccuracy.

U.S. Pat. No. 696,746B1 describes a method which represents an improved method for feeding in HF signals.

DE10393429 describes a method in which the rotor position is estimated by feeding in a HF signal.

In several patent specifications, the resulting currents or the respective counter-electromotive force are measured, e.g. US2002043953A1, US200900398410A1, EP500295B1.

These previous methods comprise several disadvantages. Methods based on the detection of the counter-electromotive force lose their accuracy at low rotational speeds and are unable to detect the rotor position at a standstill. Methods based on position-dependent inductance allow for the position of the rotor to be detected at a standstill as well, but require considerable saliency.

In the previous methods based on position-dependent inductance, a current or voltage signal is injected as a non-zero sequence (αβ or DQ sequences), i.e. the neutral point is isolated. Since the signal is injected in the form of a non-zero component, this reduces the usable voltage area which remains for controlling the motor. These methods comprise a low sensitivity with regard to the saliency and the inertial dynamics, and the injected signal for the detection of the rotor position causes interaction with the current control circuit.

### Aim

The aim of the invention at hand is to eliminate the disadvantages of the state of the art by means of an arrangement and a method for analysis of the signals received.

### Achievement of this Aim

This aim will be achieved according to the present invention via a circuit arrangement in an electric motor, in which the neutral point of the stator coils is combined with a filter.

The filter consists of at least one capacitor. In a combination consisting of this capacitor and a coil, the filter comprises an LC circuit. In a combination consisting of the aforementioned capacitor and a resistor, the filter comprises an RC circuit. The filter is configured as a high-pass filter.

The Clarke transformation is used for the detection of the rotor position. In doing so, the voltages at the stator coils are transformed into two non-zero sequences (u_{α} and u_{β}) and one zero sequence (u₀):

$$[ \begin{matrix}{u}_{α} \\ {u}_{β} \\ {u}_{0}\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2} \\ \frac{1}{2} & \frac{1}{2} & \frac{1}{2}\end{matrix} ] \cdot [ \begin{matrix}{u}_{U} \\ {u}_{V} \\ {u}_{W}\end{matrix} ]$$

wherein u_{U}, u_{V} and u_{W} refer to the voltages of the stator coils U, V and W.

A high-frequency (HF) voltage signal is injected into the zero sequence. The filter at the neutral point causes the transmission of the HF signal and inhibits the other frequency components of the zero sequence.

There are several ways to inject the HF signal. The first option is to either directly connect a signal generator to the neutral point, or connect it to the filter at the neutral point via a transformer. The frequency ranges from 1 to 100 kHz. The second option concerns the use of pulse-width modulation (PWM) in motors with inverters. The filter in the neutral point is connected to the inverter. Through this, the zero-sequence of the inverter can act on the motor coils. The PWM-controlled inverter produces a zero-sequence with a frequency equal to the switching frequency of the inverter. Harmonics of the switching frequency or an HF signal with low frequency applied through PWM may also be used.

For both options, a higher frequency can be injected than in conventional methods. This, in turn, allows faster dynamics in the detection of the position of the rotor. There are magnetic saliencies in most motors, even if only in small measures. Due to these magnetic saliencies, a current share in the non-zero sequence (i_{α} and i_{β}) is injected into the HF voltage signal. From this, the rotor position can be detected.

$$[ \begin{matrix}{i}_{α} \\ {i}_{β} \\ {i}_{0}\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2} \\ \frac{1}{2} & \frac{1}{2} & \frac{1}{2}\end{matrix} ] \cdot [ \begin{matrix}{i}_{U} \\ {i}_{V} \\ {i}_{W}\end{matrix} ]$$

wherein i_{U}, i_{V} and i_{W} are the currents of the stator coils U, V and W.

There are several variants which may be applied to detect the position of the rotor. When a signal generator injects the HF signal, the measured current has to be filtered first in order to eliminate any other frequency components which do not correspond to the frequency of the HF signal.

For an injected voltage:

u₀=a_{C} cos(ω_{C}t),

wherein a_{C} is the value and ω_{C} is the angular frequency of the HF signal, this approximately results in:

$${i}_{α} = \frac{{a}_{C} {k}_{C}}{{ω}_{C}} cos ( 2 θ ) sin ( {ω}_{C} t ) , \\ {i}_{β} = - \frac{{a}_{C} {k}_{C}}{{ω}_{C}} sin ( 2 θ ) sin ( {ω}_{C} t ) ,$$

wherein k_{C} is a constant that depends on the motor, and θ is the rotor position. The constant k_{C} is up to four times higher than in conventional methods, where the HF voltage signal is injected into the non-zero sequence.

The filtered current signals i_{α} and i_{β} are demodulated. Demodulation occurs through multiplication of the current signals with the signal sin(ω_{C}t) and is filtered using a subsequent low-pass filter. Another option involving demodulation is the synchronous sampling of the current signals at moments when ω_{C}t=π/2+2π k is the sample number with kεc. After this demodulation, this results in:

$${i}_{α k} = \frac{{a}_{C} {k}_{C}}{{ω}_{C}} cos ( 2 θ )$$

$${i}_{β k} = - \frac{{a}_{C} {k}_{C}}{{ω}_{C}} sin ( 2 θ )$$

The rotor position is detected as the rotor angle by calculating arctan 2 of the two demodulated signals and subsequently dividing it by 2:

2θ=a tan 2(−i_{βk},i_{αk})

Alternatively, the rotor position can be detected from the two demodulated signals via a phase-locked loop.

If the HF signal is injected via pulse-width modulation (PWM), there are also other ways to detect the position of the rotor.

In standard space vector pulse-width modulation (PWM), this results in a zero-sequence that is approximately rectangular, and whose frequency is equal to the switching frequency of the inverter.

As a rule, in inverter-fed motors the current is synchronously sampled to the pulse-width modulation. The moments when the current is sampled are staggered at intervals of 90 degrees from the zero crossing of the zero sequence.

In order that the position can be detected according to the current invention, the current values should be sampled immediately before the zero crossing of the zero sequence. This is possible by shifting the moment of sampling or by modifying the space vector pulse-width modulation.

Lower frequency components are eliminated by deducting the present current value from the previously sampled current value:

i_{αdif k}=i_{αk}−i_{α(k-1)}

i_{βdif k}=i_{βk}−i_{β(k-1)}

wherein kεc is the sample number.

Subsequently, the resulting current signals i_{αdif k} and i_{βdif k} are demodulated by changing the algebraic sign for every second sampling period:

i_{αdem k}=i_{αdif k}(−1)^{(k+1)}

i_{βdem k}=i_{βdif k}(−1)^{(k+1)}

The demodulated signals i_{αdem k} and i_{βdem k} are then filtered with a low-pass filter by, for example, averaging the present value and the value of the previous sampling period:

i_{αav k}=½(i_{αdem k}+i_{αdem(k-1)})

i_{βav k}=½(i_{βdem k}+i_{βdem(k-1)})

In case of magnetic saliencies in the motor, this results in:

i_{αav k}=a_{C}T_{S}k_{C} cos(2θ)

i_{βav k}=−a_{C}T_{S}k_{C} sin(2θ)

wherein T_{S} is the sampling period.

The rotor position is detected as the rotor angle by calculating arctan 2 of the signals i_{αav k} and i_{βav k}, and subsequently dividing it by 2. Alternatively, the rotor position can be detected from the two signals via a phase-locked loop (PLL). The speed of the rotor can be determined by detecting the angle.

The HF signal is either constantly fed in or the PWM emits a signal for the generation or injection of the HF signal. The current values are sampled accordingly by either emitting a signal from the PWM to determine the current share or by constantly determining the current share.

Another alternative is to generate the HF signal via the PWM, by emitting a pulse from the PWM for the zero crossing as an HF signal with a frequency ranging from 1 kHz to 100 Khz, preferably 75 kHz. After the HF signal is transmitted through the neutral point and the filter connected to the neutral point, the current share is detected. Through this, it is possible to send an HF signal for every zero crossing of a phase and detect the current share after the filter. Detecting the current share involves detecting a signal that is proportionate to the current share. Analysis takes place by detecting the derivation of the signal.

Another alternative is to send at least parts of the PWM pulse as an HF signal outside of the zero crossing. In doing so, no waiting time is required until the next or next but one zero crossing of a phase. For this reason, it is possible to send one HF signal in a shifted manner and to detect the current share after the filter. Alternatively, the HF signal can also be fed in addition to the PWM pulse e.g. during the zero crossing or in the periods between two PWM pulses.

The rotor position is calculated via trigonometric functions taken either from the current share detected or from the current share signal. Alternatively, the rotor position can be detected by analysing the current signal via a phase-locked loop (PLL).

In another embodiment, a filter is connected to the neutral point of the stator coils. The filter comprises a capacitor and an LC circuit or RC circuit. The filter is connected to a voltage source. The voltage source comprises a signal generator and an inverter or the PWM signal generator. At least two stator coils are connected to one current measuring device each. The current measuring device comprises a transformer, one or more coils with or without ferrite core, individual wire windings with or without ferrite core, conductive paths with ferrite core on a double-sided or single-sided printed circuit board.

There are no limits to the dimensions of the rotor. Rotors with a diameter ranging from 3 mm to 5 m are preferably used; particularly preferable from 1 cm to 30 cm. The number of poles is not limited either. Motors with a number of poles between 3 and 100 are preferably used; particularly preferable are motors with a number of poles between 7 and 50. The HF signal is fed in addition to the PWM pulse.

Furthermore, an HF voltage signal is fed into the neutral point of the stator windings during a PWM pulse. The HF signal passes through the stator coils. The HF signal that the stator coils passed through produces a non-zero sequence in the three-phase system (alpha-beta or d-q-sequence). A current share signal is produced from this non-zero sequence. The current share signal comprises the current share, another signal in proportion to the current share, or the derivation of the current share.

The rotor position is calculated via trigonometric functions taken either from the current share detected or from the current share signal.

The rotor position can be identified more precisely by using a value table, smoothing functions, or statistical functions.

### EMBODIMENTS

FIG. 1 shows a block diagram which is used to detect the rotor position by injecting the HF signal via a signal generator. In doing so, the motor 1θ1 is powered by an arbitrary motor power supply 100 (e.g. the grid or an inverter). The neutral point of the motor is connected via the filter with a signal generator 103, which injects an HF signal in the zero sequence. The signal generator 103 is connected to the ground of the motor's power supply. The resulting current is collected by a current transformer 104, which simultaneously carries out the Clarke transformation (see FIG. 2) in order to extract the non-zero sequence. The samplers synchronised to the signal generator and the A/D converter 106 demodulate and digitise the signals. Further signal processing occurs digitally (e.g. via a microcontroller or FPGA). The signal filtered via a low-pass filter 107 is used to calculate the rotor angle θ 109 via arctan 108.

FIG. 2 shows a current transformer arrangement 104 which carries out the Clarke transformation.

FIG. 3 shows the invention being used in a motor drive system with rotor position control when the HF signal is injected via a signal generator. An HF voltage signal 301 is fed into an amplifier 302. The HF signal passes the capacitor (LC circuit) 304 and spreads into the stator coils. The current shares per stator coil are read 306, filtered 307, and the rotor position is detected in the form of an angle 309.

FIG. 4 shows a block diagram which is used to detect the rotor position by injecting the HF signal via the PWM-controlled inverter. In doing so, control signals are generated for the motor 402 using pulse-width modulation. These control signals are fed to the motor 402 via an inverter 401.

The neutral point of the motor is closed via the filter 403 with the inverter's intermediate circuit 401. In this way, the PWM-controlled zero sequence acts on the motor coils.

The resulting current is collected by a current transformer 404. Following a synchronized sampling 405 with the PWM 400, the analog current signal is converted into a digital signal 405. The sampled current signal is transformed from phase values to a space vector (Clarke transformation) 406, thereby extracting the non-zero sequence. The present current values are deducted from the previously sampled current values 407 in order to eliminate low-frequency components. Demodulation occurs by changing the algebraic sign for every second sampling period 408. The mean value of the signal, as derived over a sampling period 409, is used to calculate the rotor angle θ 411 via arctan 410.

FIG. 5 shows the circuit of the filter connected to the neutral point of the motor and the intermediate circuit of the inverter. The inverter thereby functions as a voltage source and feeds an HF signal into the filter. This HF signal passes through the neutral point and the stator coils. After the stator coils, a signal showing the current value is detected.

FIG. 6 shows the invention being used in a motor drive system with rotor position control when the HF signal is injected via the PWM-controlled inverter.

FIG. 7 (a) shows the control signals of a modified space vector pulse-width modulation. FIG. 7 (b) shows the corresponding control signals of the inverter. FIG. 7 (c) shows the zero sequence produced which serves to generate the HF signal. The sampling times (701, 702 and 703) are located directly before the zero crossings of the HF signal.

FIG. 8 shows the demodulated and filtered current signals i_{αav} and i_{βav} as the function of the position.

### FIGURES AND LIST OF REFERENCE NUMERALS

FIG. 1 Block diagram for the detection of the rotor position

FIG. 2 Current share detection

FIG. 3 Block diagram for the detection of the rotor position

FIG. 4 Block diagram for the detection of the rotor position

FIG. 5 Circuit of the inverter, motor and neutral point filter

FIG. 6 Block diagram for the detection of the rotor position

FIG. 7 HF signal in the zero sequence

FIG. 8 Demodulated and filtered current signals

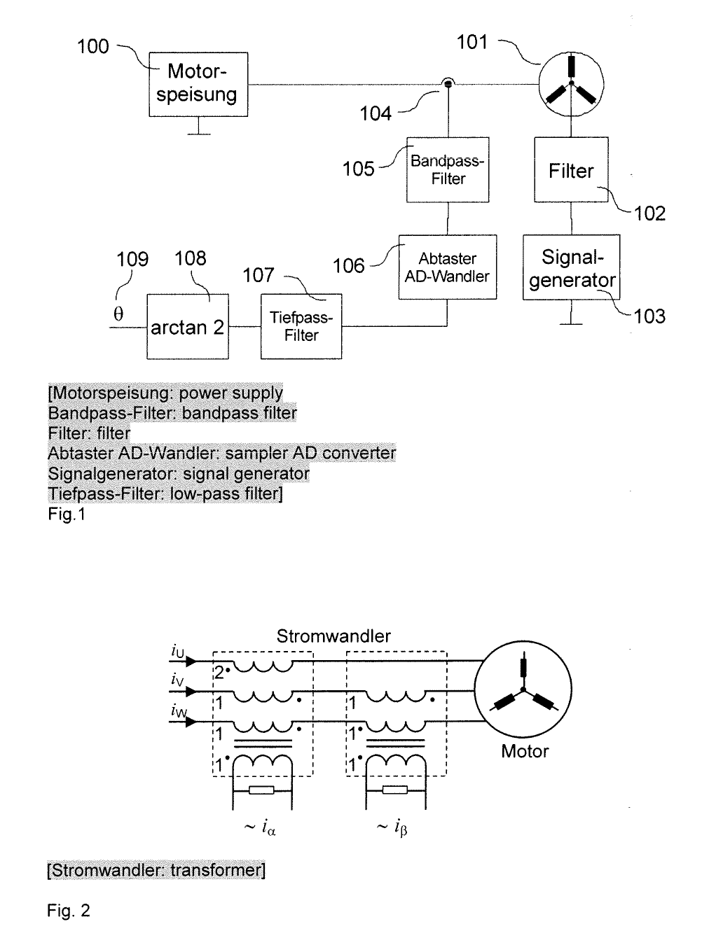

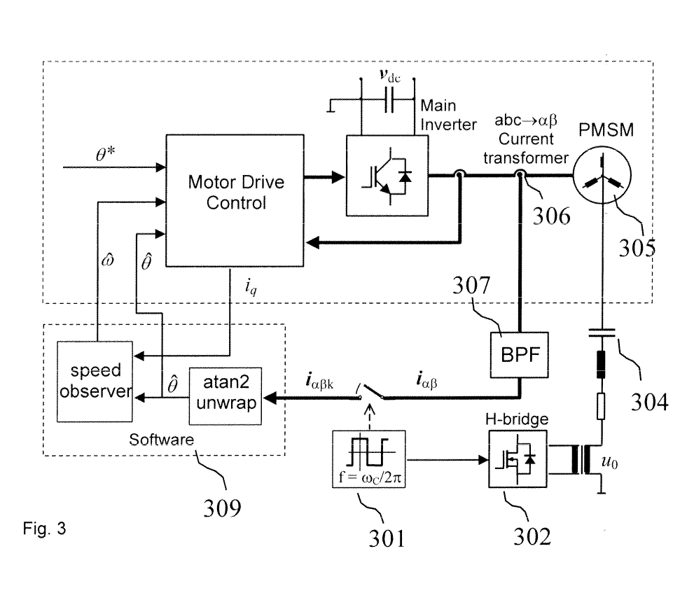

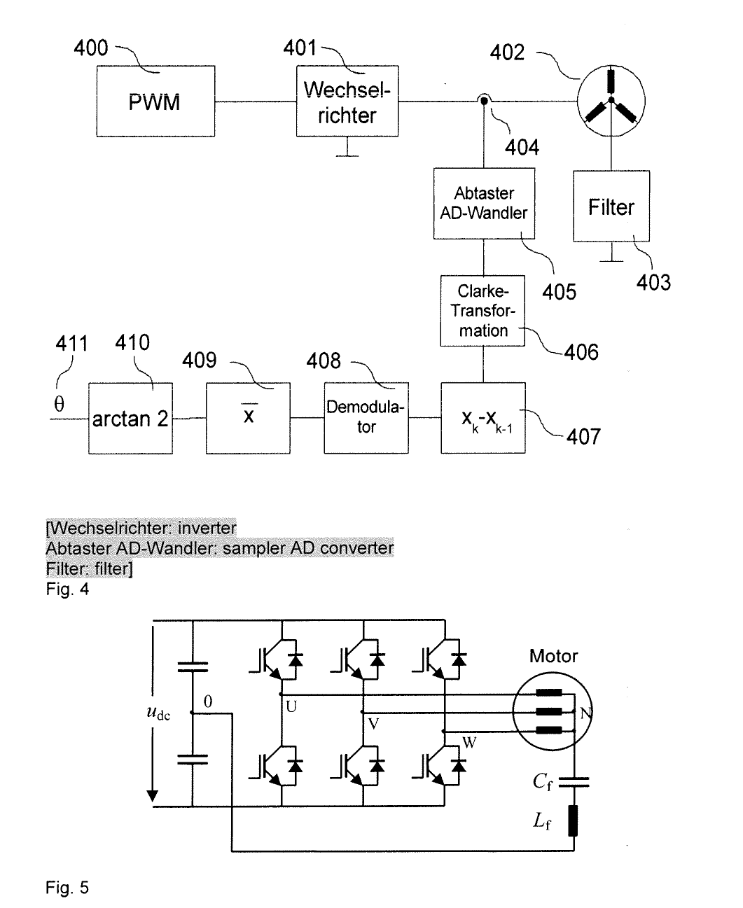

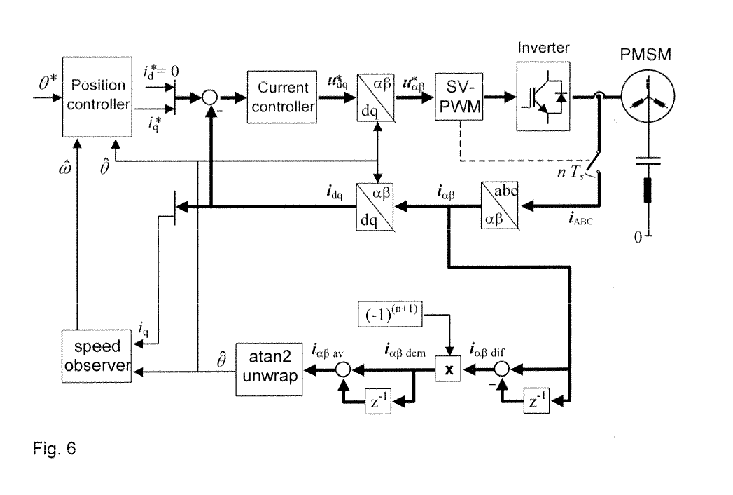

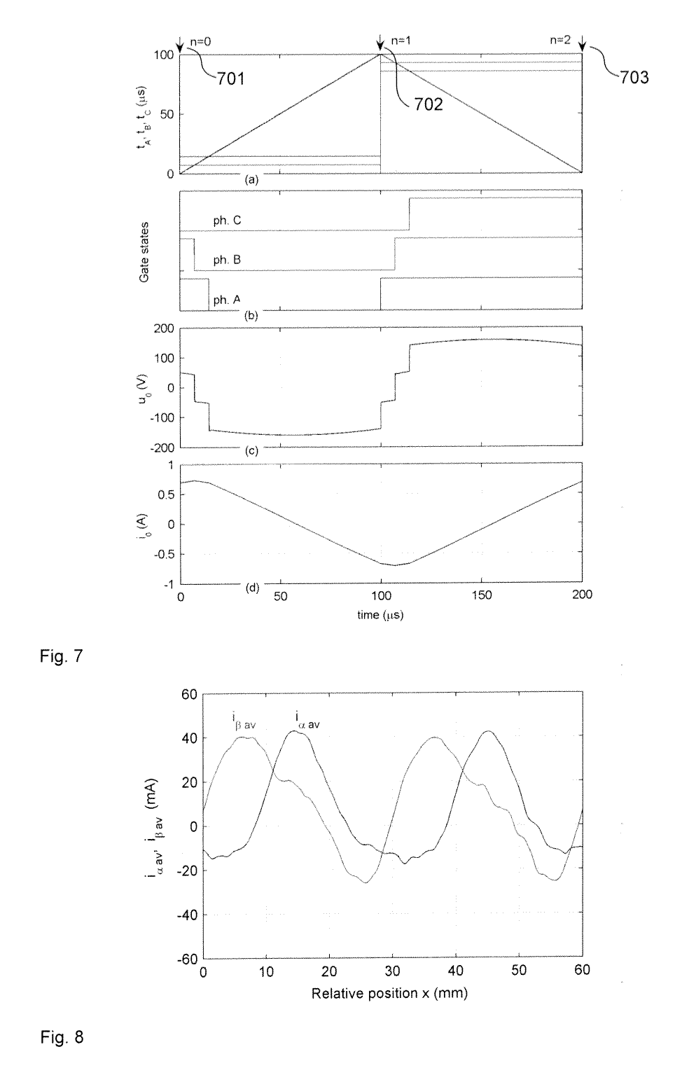

1. An arrangement for the detection of the rotor position, wherein the neutral point comprises a connection to a filter with a voltage source.

2. An arrangement according to claim 1, wherein the voltage source comprises a signal generator, an inverter, or the PWM signal generator.

3. An arrangement according to claims 1 to 2, wherein the filter comprises a capacitor, an LC circuit, or an RC circuit.

4. An arrangement according to claims 1 to 3, wherein the neutral point comprises a connection to the stator coils, wherein at least two stator coils comprise one current measuring device each.

5. An assembly group for the detection of the rotor position is, wherein this group comprises at least one filter with voltage source which is connected to a neutral point, and an analysis unit.

6. A method for the detection of the rotor position, wherein a high-frequency (HF) signal is injected and is passed via a filter, according to claim 3, connected to the neutral point.

7. A method according to claim 6, wherein an HF signal is injected into the zero sequence.

8. A method according to claims 6 to 7, wherein the HF signal is injected into the zero sequence via a pulse-width modulation-controlled inverter.

9. A method according to claims 6 to 8, wherein via an HF current signal in the non-zero sequence an HF voltage signal in the non-zero sequence is produced.

10. A method according to claims 6 to 9, wherein the current share of the HF voltage signal is detected in an analysis unit and converted into a rotor angle via trigonometric functions.

11. A method according to claims 6 to 10, wherein the current value of the HF voltage signal is detected in an analysis unit and converted into a rotor angle via a phase-locked loop.

12. A method according to claims 6 to 11, wherein the HF voltage signals produced comprise a frequency ranging from 1 kHz to 100 kHz, preferably 25 kHz.

13. A method according to claims 6 to 12, wherein the HF signals are passed firstly through the filter and then through the neutral point.

14. A method according to claim 6, wherein the pulses produced by the PWM are at least partly realized in the form of HF voltage signals with a frequency ranging from 1 kHz to 100 kHz, preferably 75 kHz.

15. A method according to claims 6 and 14, wherein the HF voltage signals are passed firstly through the neutral point and then through the filter.

16. A method according to claims 6, 14 to 15, wherein the current share of the HF voltage signal is detected in an analysis unit and converted into a rotor angle via trigonometric functions.

17. A method according to claims 6, 14 to 16, wherein the current share of the HF voltage signal is detected in an analysis unit and converted into a rotor angle via a phase-locked loop.
